(19) United States
(12) Patent Application Publication
(10) Pub. No.: US 2024/0191802 A1
(43) Pub. Date: Jun. 13, 2024

(54) OZONE WATER CONTROL VALVE

(71) Applicant: Hsiang-Shih Wang, Changhua (TW)

(72) Inventor: Hsiang-Shih Wang, Changhua (TW)

(73) Assignee: GEANN INDUSTRIAL CO.,LTD., CHANGHUA (TW)

(21) Appl. No.: 18/078,922

(22) Filed: Dec. 10, 2022

(51) Int. Cl. F16K 3/26; C02F 1/00; C02F 1/78; E03C 1/04

(52) U.S. Cl. CPC F16K 3/262; C02F 1/001; C02F 1/78; E03C 1/0404; C02F 2201/005; E03C 2201/40

(57) ABSTRACT

An ozone water control valve may include a first water outlet head, a first connector, and a rotary knob. The first water outlet head has a water chamber axially penetrating through the first water outlet head, and a lateral hole is formed at the lateral side of the first water outlet head to communicate with the water chamber. The first connector comprises an annular base, a rotary control section, and a connecting section, and the connecting section is connected to an ozone device. The ozone device is connected to the first water outlet head through the first connector and the lateral hole, and with the rotary knob, the water control valve can be switched between the ozone water and tap water quickly and accurately, so as to greatly improve the convenience of use.

### FIELD OF THE INVENTION

The present invention relates to an ozone water control valve and more particularly to an ozone water control valve available that can switch between ozone water and tap water.

### BACKGROUND OF THE INVENTION

Ozone is the allotrope of oxygen. In the process of ozone decomposition into oxygen, oxygen atoms will free out, because the oxidation of oxygen atoms is quite active, strong reactivity, and oxidation power is second only to fluorine, so that ozone can have sterilization, deodorization, purification effect in the reduction process. Thus, some manufacturers launch the products of water device connecting with the ozone generator so that the tap water can be mixed with the ozone to achieve sterilization, deodorization and purification effect.

However, the conventional ozone water device has following disadvantages: (i) when consumers want to use the above-mentioned ozone water equipment, additional water inlet pipe and water outlet devices are required to install, which greatly increases installation costs, space, and labor and material costs; and (ii) the conventional ozone water device can only control on/off water without a switching function, so that the user need to switch back and forth between multiple faucets, which seriously lowers the convenience of use. Therefore, there remains a need for a new and improved design for an ozone water control valve to overcome the problems presented above.

### SUMMARY OF THE INVENTION

The present invention provides an ozone water control valve comprising a first water outlet head, a first connector, and a rotary knob. The first water outlet head has a water chamber axially penetrating through the first water outlet head, and a lateral hole is formed at the lateral side of the first water outlet head to communicate with the water chamber. The first connector comprises an annular base, a rotary control section, and a connecting section which are formed integrally with the first connector. A locating protrude protrudes from one end of the annular base toward the rotary control section, and the other end of the annular base has a protruding axle on the center thereof to connect to the lateral hole. A first water channel axially penetrates from the end of the protruding axle toward the interior space of the rotary control section, and a first hole channel and a second hole channel respectively penetrate through two lateral sides of the rotary control section to communicate with the first water channel. A second water channel axially penetrates from the end of the connecting section toward the interior space of the rotary control section without communicating with the first water channel, and a third hole channel penetrates through the lateral side of the rotary control section to communicate with the second water channel, and the first hole channel and the third hole channel are formed in parallel on the same lateral side of the rotary control section. The rotary knob has an axial space axially penetrating from one end of the rotary knob to the other end, and the rotary knob is rotatably disposed on the rotary control section of the first connector through the axial space. One end of the rotary knob is abutted against the annular base of the first connector, and a locating groove is formed at the end of the rotary knob to couple with the locating protrude. The inner wall of the axial space comprises a communicating slot and a communicating hole which are formed separately, and an air inlet channel axially penetrates through the end of the rotary knob to communicate with the communicating hole, and the connecting section of the first connector is connected to an ozone device. When one end of the locating groove of the rotary knob is abutted against the locating protrude to secure the position thereof, the communicating slot is aligned with the first hole channel and the third hole channel, so as to communicate the first hole channel with the third hole channel. The ozone of the ozone device is adapted to pass through the first hole channel and the third hole channel into the first water outlet head. On the other hand, when the other end of the locating groove is abutted against the locating protrude to secure the position thereof, and the communicating slot is positioned away from the first hole channel and the third hole channel, and the communicating hole is aligned and communicated with the second hole channel, so as to block the ozone and import the air, so as to achieve on/off operation of ozone.

In one embodiment, a water filter is installed in the water chamber, and a first inner threaded section is formed on the inner periphery of the upper portion of the water chamber, and an adapter is connected to the first water outlet head through the first inner threaded section; the adapter has an outer threaded large section and an outer threaded small section, and the outer threaded small section is engaged with the first inner threaded section while the outer threaded large section is connected to the water outlet of the faucet.

In another embodiment, an engaging groove is formed on the outer periphery of the lateral hole, and the annular base is engaged into the engaging groove; the protruding axle is screw-locked with the lateral hole, and a first peripheral groove is formed on the outer periphery of the protruding axle, and a first O-ring is disposed on the first peripheral groove.

In still another embodiment, a second connector integrally formed on the lower portion of the first water outlet head comprises an axial water outlet channel which is communicated with the water chamber, and the first water outlet head is connected to a second water outlet head at the lower portion through the second connector; the second water outlet head has a shell and an inner base, and a through hole axially penetrates through the shell, and the second connector passes through the through hole into the shell; a second inner threaded section is formed on the inner periphery of the shell, and the upper end of the inner base comprises a connecting hole having a concaved arc inner periphery while a second outer threaded section is formed on the outer periphery of the inner base; the inner base is bottom-up screw-locked in the shell, and the connecting hole of the inner base is coupled on the lower portion of the second connector so as to enable the second water outlet head to rotate along the second connector in different angles, thereby achieving the purpose of changing the direction of water flow.

In a further embodiment, the second water outlet head comprises a fourth O-ring coupled between the shell and the inner base, and a third O-ring disposed on the inner periphery of the connecting hole of the inner base is abutted against the surface of the second connector.

In still a further embodiment, a splitter plate is formed inside the inner base of the second water outlet head, and the splitter plate comprises a plurality of protruding ribs respectively and radially protrude from the peripheral of the splitter plate to connect to the inner wall of the inner base, and each of splitter holes is formed between two adjacent protruding ribs.

In an advantageous embodiment, each of two ends of the rotary control section has a second peripheral groove, and two second O-rings are respectively disposed on the two second peripheral grooves.

Comparing with conventional ozone water control valve, the present invention is advantageous because: (i) the ozone device is connected to the first water outlet head through the first connector and the lateral hole, and with the rotary knob, the water control valve can be switched between the ozone water and the tap water quickly and accurately, so as to greatly improve the convenience of use; and (ii) the ozone water and the tap water are used through the same first water outlet head, so that there is no need to install another ozone faucet, which effectively saves the costs and space.

### BRIEF DESCRIPTION OF THE DRAWINGS

FIG. 1 is a three-dimensional assembly view of an ozone water control valve of the present invention.

FIG. 2 is a three-dimensional exploded view of the ozone water control valve of the present invention.

FIG. 3 is a sectional assembly view of the ozone water control valve of the present invention.

FIG. 4 is a sectional view illustrating a rotary knob of the ozone water control valve is at ozone on position in the present invention.

FIG. 5 is a schematic view illustrating the ozone is imported through a first connector into a first water outlet head of the ozone water control valve in the present invention.

FIG. 6 is a schematic view of the ozone water control valve when water is in use from the first water outlet head.

FIG. 7 is a schematic view illustrating a second connector of the ozone water control valve enables the first water outlet head to be used in different angles.

FIG. 8 is a sectional view illustrating the rotary knob of the ozone water control valve is at ozone off position in the present invention.

FIG. 9 is a schematic view illustrating the ozone is turned off and outside air is imported into the first water outlet head of the ozone water control valve in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

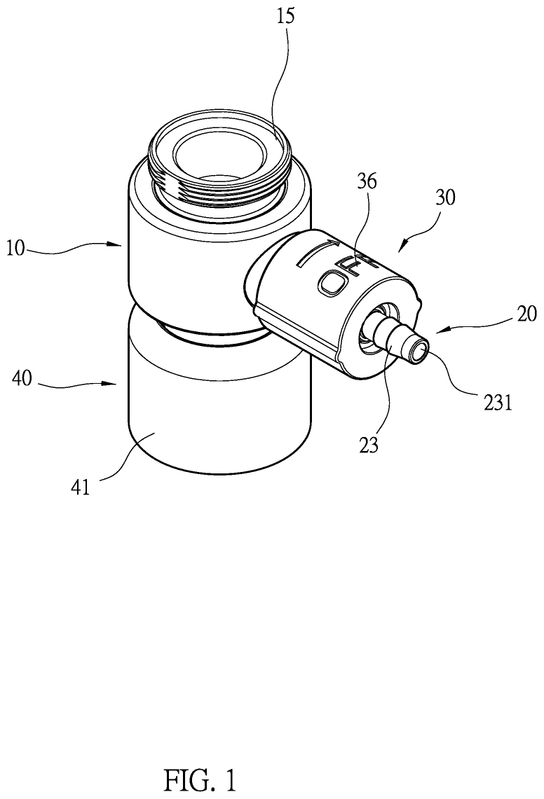

Referring to FIGS. 1,2 and 5, the present invention provides an ozone water control valve comprising a first water outlet head (10), a first connector (20), a rotary knob (30), a second water outlet head (40), and an ozone device (50). The first water outlet head (10) has a water chamber (11) axially penetrating through the first water outlet head (10), and a lateral hole (12) is formed at the lateral side of the first water outlet head (10) to communicate with the water chamber (11). An engaging groove (121) is formed on the outer periphery of the lateral hole (12), and a second connector (13) integrally formed on the lower portion of the first water outlet head (10) is configured to connect with the second water outlet head (40). The second connector (13) comprises an axial water outlet channel (131) which is communicated with the water chamber (11), and a water filter (14) is installed in the water chamber (11). Moreover, a first inner threaded section (111) is formed on the inner periphery of the upper portion of the water chamber (11), and an adapter (15) is connected to the first water outlet head (10) through the first inner threaded section (111). The first connector (20) comprises an annular base (21), a rotary control section (22), and a connecting section (23) which are formed integrally with the first connector (20). A locating protrude (211) protrudes from one end of the annular base (21) toward the rotary control section (22), and the other end of the annular base (21) has a protruding axle (212) on the center thereof to connect to the lateral hole (12). Furthermore, a first peripheral groove (213) is formed on the outer periphery of the protruding axle (212), and a first O-ring (214) is disposed on the first peripheral groove (213). A first water channel (215) axially penetrates from the end of the protruding axle (212) toward the interior space of the rotary control section (22), and a first hole channel (221) and a second hole channel (222) respectively penetrate through two lateral sides of the rotary control section (22) to communicate with the first water channel (215). A second water channel (231) axially penetrates from the end of the connecting section (23) toward the interior space of the rotary control section (22) without communicating with the first water channel (215), and a third hole channel (223) penetrates through the lateral side of the rotary control section (22) to communicate with the second water channel (231), and the first hole channel (221) and the third hole channel (223) are formed in parallel on the same lateral side of the rotary control section (22). Each of two ends of the rotary control section (22) has a second peripheral groove (224), and two second O-rings (225) are respectively disposed on the two second peripheral grooves (224). The rotary knob (30) has an axial space (31) axially penetrating from one end of the rotary knob (30) to the other end, and the rotary knob (30) is rotatably disposed on the rotary control section (22) of the first connector (20) through the axial space (31). One end of the rotary knob (30) is abutted against the annular base (21) of the first connector (20), and a locating groove (32) is formed at the end of the rotary knob (30) to couple with the locating protrude (211). The rotation range of the locating groove (32) is 90 degrees, and the inner wall of the axial space (31) comprises a communicating slot (33) and a communicating hole (34) which are formed separately. The communicating slot (33) and one end of the locating groove (32) are located at the same axis line while the communicating hole (34) and the other end of the locating groove (32) are located at the same axis line, so as to form 90 degrees of the rotary control angle between the communicating slot (33) and the communicating hole (34), and an air inlet channel (35) axially penetrates through the end of the rotary knob (30) to communicate with the communicating hole (34). The second water outlet head (40) comprises a shell (41) and an inner base (42), and a through hole (411) axially penetrates through the shell (41). A second inner threaded section (412) is formed on the inner periphery of the shell (41), and the upper end of the inner base (42) comprises a connecting hole (421) having a concaved arc inner periphery while a second outer threaded section (422) is formed on the outer periphery of the inner base (42). Moreover, a splitter plate (423) is formed inside the inner base (42), and the splitter plate (423) comprises a plurality of protruding ribs (424) respectively and radially protrude from the peripheral of the splitter plate (423) to connect to the inner wall of the inner base (42), and each of splitter holes (425) is formed between two adjacent protruding ribs (424).

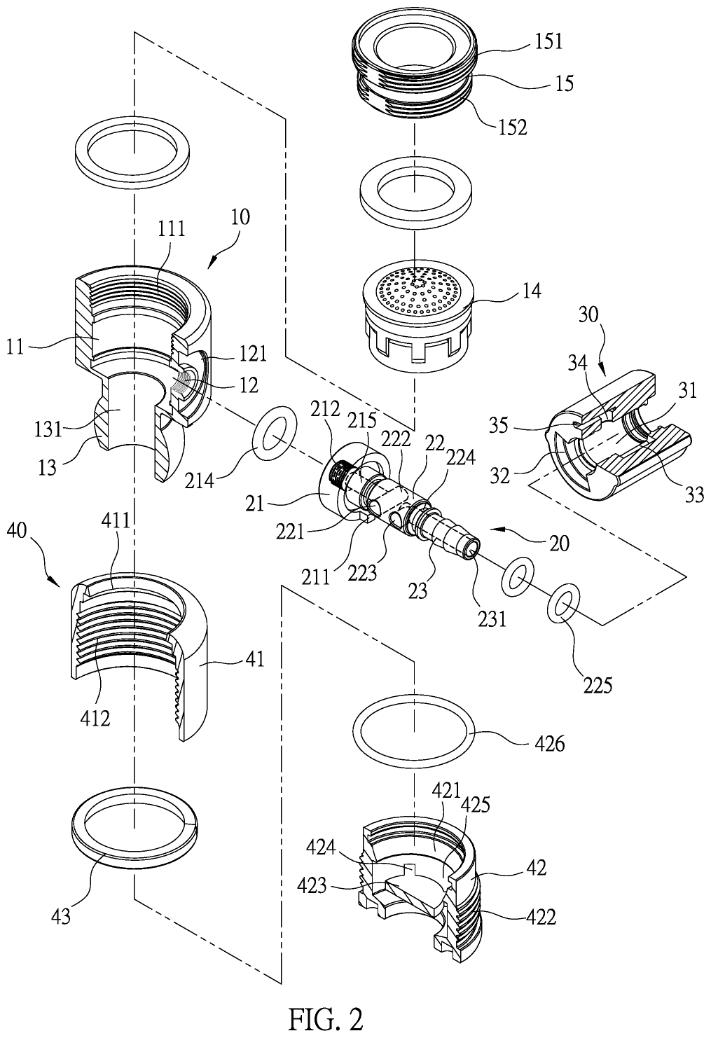

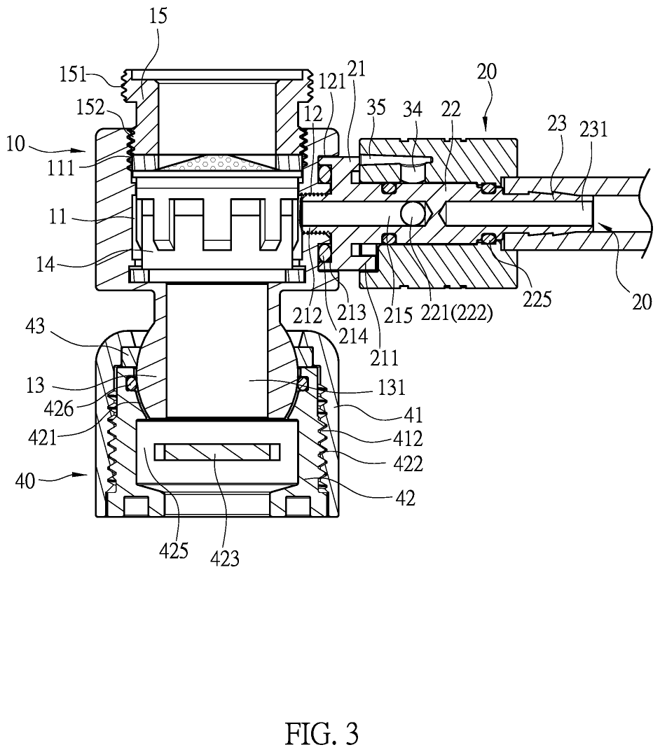

Structurally, referring to FIGS. 1 to 4, the water filter (14) is installed in the water chamber (11) of the first water outlet head (10), and the first water outlet head (10) is adapted to be connected to the water outlet of the faucet having the outer threaded portion through the first inner threaded section (111). Also, the first inner threaded section (111) is configured to connect to the adapter (15) which has one outer threaded large section (151) and one outer threaded small section (152), and the outer threaded small section (152) is engaged with the first inner threaded section (111) while the outer threaded large section (151) is connected to the water outlet of the faucet, so as to connect to different sizes and types of the water outlet. The first connector (20) is connected to the lateral hole (12) of the first water outlet head (10) through the protruding axle (212), and the first O-ring (214) is disposed on the first peripheral groove (213) of the protruding axle (212), and the protruding axle (212) is screw-locked into the lateral hole (12). Furthermore, the annular base (21) is engaged into the engaging groove (121). Each of the two second peripheral grooves (224) on the two ends of the rotary control section (22) of the first connector (20) has one second O-ring (225) disposed thereon, and the rotary knob (30) is rotatably connected on the rotary control section (22) of the first connector (20). The end of the rotary knob (30) is abutted against the annular base (21), and the locating groove (32) of the rotary knob (30) is coupled with the locating protrude (211) so as to limit the rotation range of the rotary knob (30). An indicating sign (36) is formed on the outer surface of the rotary knob (30) to indicate the rotary control mode, and the rotary knob (30) is rotated to selectively communicate the communicating slot (33) with the first hole channel (221) and the third hole channel (223) or communicate the communicating hole (34) with the second hole channel (222). Additionally, the connecting section (23) of the first connector (20) is connected to the ozone device (50). The lower end of the first water outlet head (10) is connected to the second water outlet head (40) through the second connector (13), and the inner base (42). The second connector (13) is inserted into the through hole (411) of the shell (41), and the inner base (42) is screw-locked in the shell (41), and the connecting hole (421) of the inner base (42) is coupled on the lower portion of the second connector (13) so that the connecting hole (421) having a concaved arc inner periphery is adapted to enable the second water outlet head (40) to rotate along the second connector (13) in different angles, so as to achieve the purpose of changing the direction of water flow. In addition, the second water outlet head (40) comprises a fourth O-ring (43) coupled between the shell (41) and the inner base (42), and the inner periphery of the fourth O-ring (43) is abutted against the outer surface of the second connector (13), so as to secure the position of the second water outlet head (40) after rotated, and meanwhile to keep lubricated between the second water outlet head (40) and the second connector (13), thereby improving the smoothness of the rotation of the second water outlet head (40). Moreover, a third O-ring (426) disposed on the inner periphery of the connecting hole (421) of the inner base (42) is abutted against the surface of the second connector (13), thereby achieving the water leakproof effect.

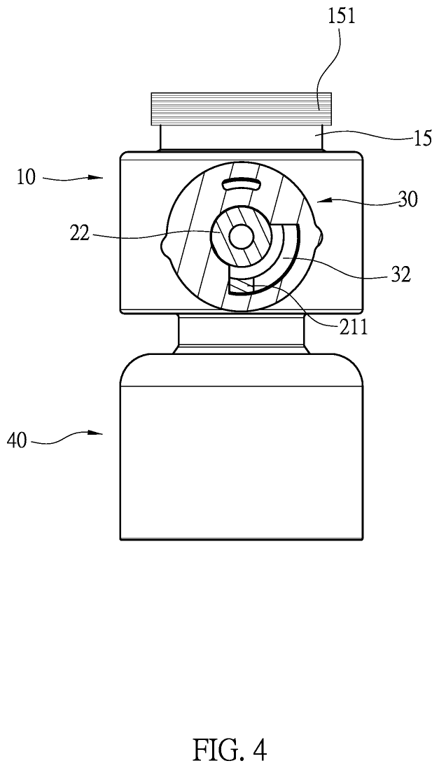

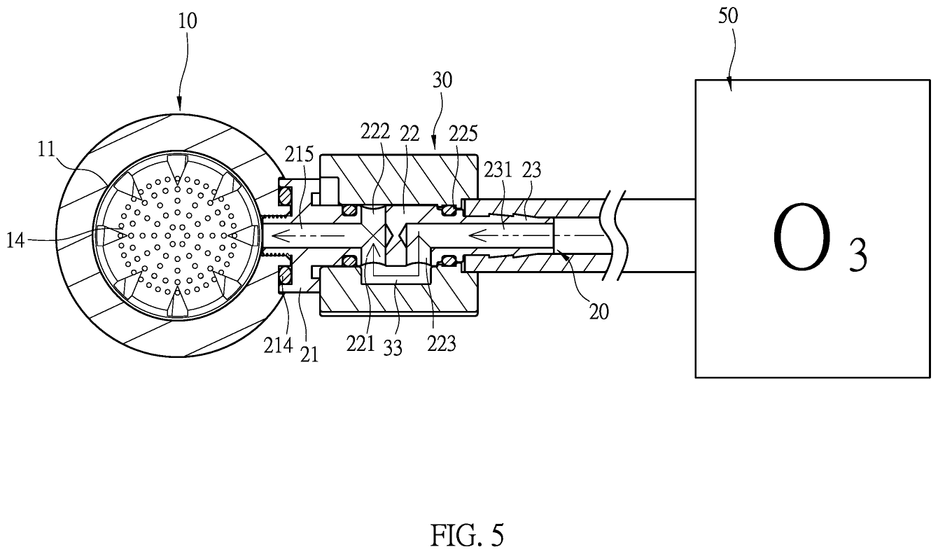

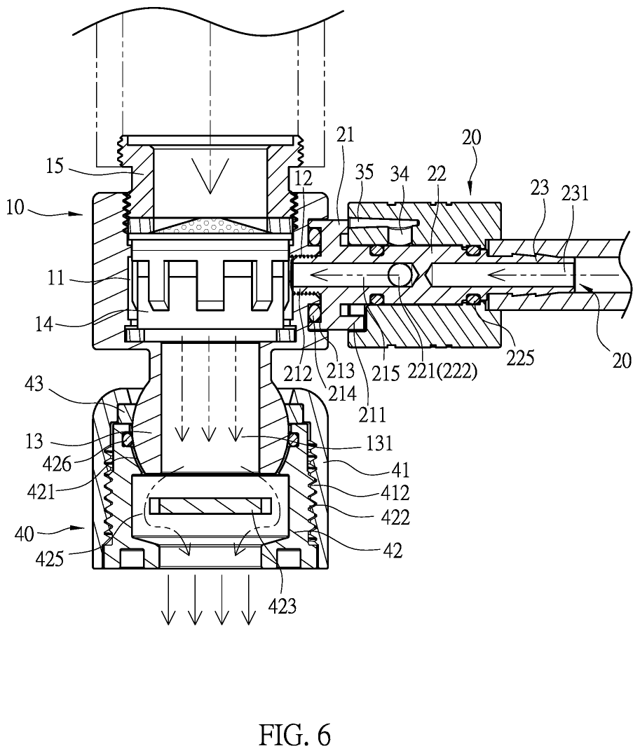

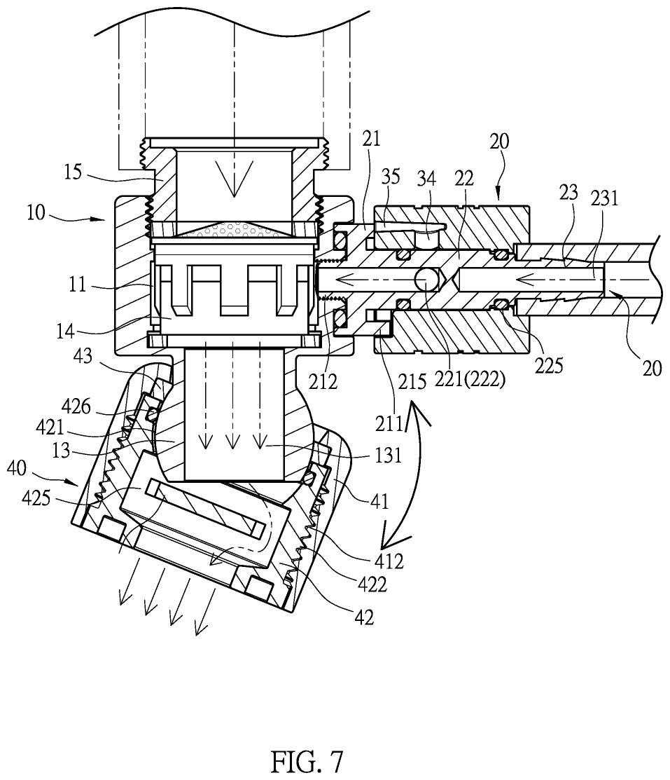

In actual application, referring to FIGS. 4 to 6, when one end of the locating groove (32) of the rotary knob (30) is abutted against the locating protrude (211) to secure the position thereof, the communicating slot (33) is aligned with the first hole channel (221) and the third hole channel (223), and the first water channel (215) and the second water channel (231) are communicated through the communicating slot (33), so as to communicate the first water outlet head (10) with the ozone device (50). When faucet is opened, the water is adapted to flow downwardly through the water chamber (11), and when the water flows through water outlet channel (131), the flow pressure is adapted to generate the negative pressure siphon effect to the lateral hole (12), so as to further activate the ozone device (50) to release ozone, and the ozone is attracted by negative pressure into the water chamber (11). Thus, the ozone is dissolved into water to enable the water control valve to provide the ozone water containing ozone molecules, so as to achieve the effects of sterilization, deodorization and other purification functions. Additionally, the outlet angle and range of the second water outlet head (40) is configured to be rotated and adjusted through the coordination between the second water outlet head (40) and the second connector (13), so as to facilitate the water use (as shown in FIG. 7).

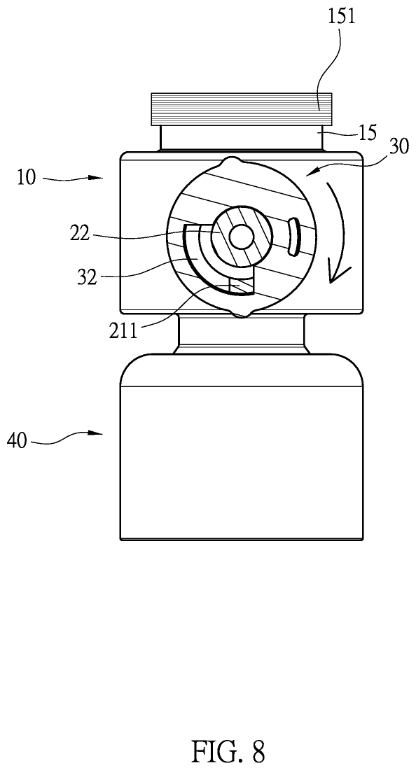

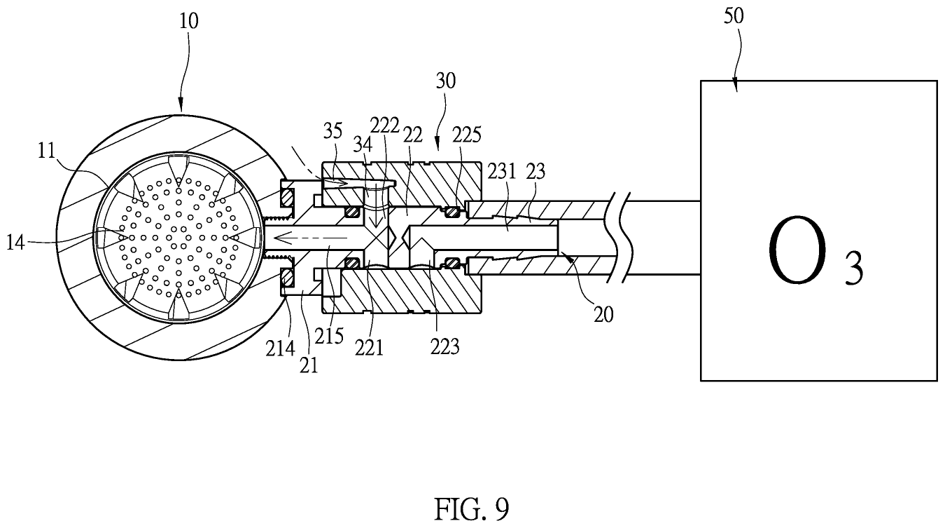

On the other hand, referring to FIGS. 8 and 9, the ozone water outlet can be turned off by rotating the rotary knob (30) to the other direction, and the other end of the locating groove (32) is abutted against the locating protrude (211), and meanwhile the communicating slot (33) is away from the first hole channel (221) and the third hole channel (223), so that the first water channel (215) and the second water channel (231) are not communicated so as to block the ozone into the first water outlet head (10), and the ozone device (50) is at off status when not receiving the negative pressure. Meanwhile, the communicating hole (34) is aligned and communicated with the second hole channel (222). When the faucet is turned on, the flow pressure generates the negative pressure siphon effect to the lateral hole (12), the outer air is configured to be imported from the air inlet channel (35) into the second hole channel (222), so as to turn off the ozone device 50 and switch to the tap water.

Comparing with conventional ozone water control valve, the present invention is advantageous because: (i) the ozone device (50) is connected to the first water outlet head (10) through the first connector (20) and the lateral hole (12), and with the rotary knob (30), the water control valve can be switched between the ozone water and the tap water quickly and accurately, so as to greatly improve the convenience of use; and (ii) the ozone water and the tap water are used through the same first water outlet head (10), so that there is no need to install another ozone faucet, which effectively saves the costs and space.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. An ozone water control valve comprising a first water outlet head, a first connector, and a rotary knob;
wherein the first water outlet head has a water chamber axially penetrating through the first water outlet head, and a lateral hole is formed at the lateral side of the first water outlet head to communicate with the water chamber; the first connector comprises an annular base, a rotary control section, and a connecting section which are formed integrally with the first connector; a locating protrude protrudes from one end of the annular base toward the rotary control section, and the other end of the annular base has a protruding axle on the center thereof to connect to the lateral hole; a first water channel axially penetrates from the end of the protruding axle toward the interior space of the rotary control section, and a first hole channel and a second hole channel respectively penetrate through two lateral sides of the rotary control section to communicate with the first water channel; a second water channel axially penetrates from the end of the connecting section toward the interior space of the rotary control section without communicating with the first water channel; a third hole channel penetrates through the lateral side of the rotary control section to communicate with the second water channel, and the first hole channel and the third hole channel are formed in parallel on the same lateral side of the rotary control section; the rotary knob has an axial space axially penetrating from one end of the rotary knob to the other end, and the rotary knob is rotatably disposed on the rotary control section of the first connector through the axial space; one end of the rotary knob is abutted against the annular base of the first connector, and a locating groove is formed at the end of the rotary knob to couple with the locating protrude; the inner wall of the axial space comprises a communicating slot and a communicating hole which are formed separately, and an air inlet channel axially penetrates through the end of the rotary knob to communicate with the communicating hole, and the connecting section of the first connector is connected to an ozone device; when one end of the locating groove of the rotary knob is abutted against the locating protrude to secure the position thereof, the communicating slot is aligned with the first hole channel and the third hole channel, so as to communicate the first hole channel with the third hole channel. The ozone of the ozone device is adapted to pass through the first hole channel and the third hole channel into the first water outlet head; when the other end of the locating groove is abutted against the locating protrude to secure the position thereof, and the communicating slot is positioned away from the first hole channel and the third hole channel, and the communicating hole is aligned and communicated with the second hole channel, so as to block the ozone and import the air, so as to achieve on/off operation of ozone.

2. The ozone water control valve of claim 1, wherein a water filter is installed in the water chamber, and a first inner threaded section is formed on the inner periphery of the upper portion of the water chamber, and an adapter is connected to the first water outlet head through the first inner threaded section; the adapter has an outer threaded large section and an outer threaded small section, and the outer threaded small section is engaged with the first inner threaded section while the outer threaded large section is connected to the water outlet of the faucet.

3. The ozone water control valve of claim 1, wherein an engaging groove is formed on the outer periphery of the lateral hole, and the annular base is engaged into the engaging groove; the protruding axle is screw-locked with the lateral hole, and a first peripheral groove is formed on the outer periphery of the protruding axle, and a first O-ring is disposed on the first peripheral groove.

4. The ozone water control valve of claim 1, wherein a second connector integrally formed on the lower portion of the first water outlet head comprises an axial water outlet channel which is communicated with the water chamber, and the first water outlet head is connected to a second water outlet head at the lower portion through the second connector; the second water outlet head has a shell and an inner base, and a through hole axially penetrates through the shell, and the second connector pass through the through hole into the shell; a second inner threaded section is formed on the inner periphery of the shell, and the upper end of the inner base comprises a connecting hole having a concaved arc inner periphery while a second outer threaded section is formed on the outer periphery of the inner base; the inner base is bottom-up screw-locked in the shell, and the connecting hole of the inner base is coupled on the lower portion of the second connector so as to enable the second water outlet head to rotate along the second connector in different angles, thereby achieving the purpose of changing the direction of water flow.

5. The ozone water control valve of claim 4, wherein the second water outlet head comprises a fourth O-ring coupled between the shell and the inner base, and a third O-ring disposed on the inner periphery of the connecting hole of the inner base is abutted against the surface of the second connector.

6. The ozone water control valve of claim 4, wherein a splitter plate is formed inside the inner base of the second water outlet head, and the splitter plate comprises a plurality of protruding ribs respectively and radially protrude from the peripheral of the splitter plate to connect to the inner wall of the inner base, and each of splitter holes is formed between two adjacent protruding ribs.

7. The ozone water control valve of claim 1, wherein each of two ends of the rotary control section has a second peripheral groove, and two second O-rings are respectively disposed on the two second peripheral grooves.
